(19) United States
(12) Patent Application Publication
(10) Pub. No.: US 2006/0045113 A1
(43) Pub. Date: Mar. 2, 2006

(54) Method for establishing high-reliability wireless connectivity to mobile devices using multi channel radios

(76) Inventor: Andrea Giuseppe Palisca, San Francisco, CA (US)

Correspondence Address: FAY KAPLUN & MARCIN, LLP, 15O BROADWAY, SUITE 702, NEW YORK, NY, 10038, US

(21) Appl. No.: 10/930,268

(22) Filed: Aug. 31, 2004

(51) Int. Cl. H04J 3/22; H04J 3/16; H04L 12/28; H04B 7/216

(52) U.S. Cl. 370/431; 370/465

(57) ABSTRACT

A method of using a high throughput multi-channel wireless network client apparatus, comprising running a driver software on an intelligence unit, running a firmware code on a multi-channel radio unit, scanning a network environment for available channels, generating a list of available access points in said network environment, choosing a plurality of available access points based on a custom method, establishing multiple concomitant radio connections with all chosen access points, exchanging data between the high throughput multi-channel wireless network client apparatus and said network, and maintaining continuously an ideal set of concomitant radio connections.

### TECHNICAL FIELD

The present invention generally relates to wireless network client devices. More particularly, the present invention relates to methods and apparatuses that enable the wireless network (WLAN) client devices to make use concomitantly of multiple channel access and transmittal capabilities.

### BACKGROUND OF THE INVENTION

Single channel WLAN access points (APs) have limited capabilities to enable enterprise-class network management. This is because only a single radio channel is available for handling both data communications and wireless (WLAN) management. The single channel makes efforts to handle both tasks. Today's WLAN management solutions that address this problem fall into two categories: single-channel integrated channel scanning solutions and network monitoring overlays.

Single-channel integrated channel scanning solutions utilize single-channel APs to monitor the network for anomalies, network status and unauthorized devices by periodically stopping data communications in order to scan all available WLAN channels for unauthorized WLAN activity. This method is disruptive to data communications, and even more so to voice communications, as the network traffic flow is interrupted each time an AP goes offline to monitor the network. Further, it only actually monitors the network during the short period that the AP is performing channel scanning, leaving the network unmonitored for the majority of time.

The network monitoring WLAN overlay method provides dedicated WLAN monitoring devices deployed throughout the enterprise to ‘listen’ to the network in order to monitor the network. This method is an improvement over the single-channel scanning method, however it requires an additional set of WLAN hardware, often from a different vendor than that of the deployed APs, to purchase, install, maintain and manage. This results in incremental cost to an IT department.

Single-channel network client devices present a set of challenges, as well. While using 802.11a, 802.11b, or 802.11g protocols, a wireless mobile client device maintains connection with the network via a plurality of WLAN access points. If the RF environment changes, for example, due to RF interference, due to a change in the physical environment of the client device, or due to the movement of the mobile client device, the mobile client device temporarily looses connectivity with the network access point.

In this case, the network client device has to connect to a different access point, if one is available, or remain disassociated for a period of time. In either case, the communication flow is interrupted for a period of time. Due to the inherent characteristics of a wireless connection, it is not unusual that connectivity between a mobile unit and the wireless network is intermittent.

Current solutions that address the above problem attempt to improve the reliability of the single radio connection that unites the single-channel client device with the network. This can be done by attempting to improve the quality of the single radio connection at the functional or at the software level. Currently none of these solutions are efficient and/or cost effective and achieve continuous connectivity, reliability and high throughput.

Accordingly, improved and cost effective methods and apparatuses for achieving permanent connectivity, a higher throughput of data and better reliability are necessary, both for access points and for the client devices.

### BRIEF SUMMARY OF THE INVENTION

The present invention consists of a method of using a high throughput multi-channel wireless network client apparatus that comprises the steps of running a driver software on an intelligence unit embedded into the multi-channel wireless network client apparatus, running a firmware code on a multi-channel radio unit pertaining to the same apparatus, scanning the network environment for available channels, generating a list of available access points in the network environment, choosing a plurality of available access ports based on a custom method, establishing multiple concomitant radio connections with all chosen access points, and exchanging data between the high throughput multi-channel wireless network client apparatus and said wireless network.

The present invention also consists of an environment to practice the above method, a high throughput multi-channel wireless network client apparatus, that comprises a multi-channel system for communication with a wireless network, means for associating the multi-channel radio system with the wireless network, and internal antenna assembly, operatively and functionally connected to the client apparatus.

The foregoing and other features and advantages of the present invention will be apparent from the following more particular description of the preferred embodiments of the invention, as illustrated in the accompanying drawings.

### BRIEF DESCRIPTION OF THE DRAWINGS

The present invention is described with reference to the accompanying drawings. In the drawings, like reference numbers indicate identical or functionally similar elements. Additionally, the left most digit(s) of a reference number identifies the drawing in which the reference number first appears.

FIG. 1 illustrates a wireless LAN with a plurality of single-channel network client devices, sharing a single communication channel.

FIG. 2 illustrates a wireless LAN with a plurality of multi-channel wireless network client devices that maintain multiple contacts with a plurality of access points, according with one aspect of the present invention.

FIG. 3 is a table illustrating a comparison between the wireless 802.11g LAN throughput of single-channel network client devices and 802.11g multi-channel wireless network client devices that maintain concomitantly multiple contacts with a plurality of access points.

FIG. 4 illustrates a wireless LAN with a plurality of single-channel network client devices, sharing a single communication channel with the APs, challenged by the presence of an obstacle in its environment.

FIG. 5 illustrates a wireless LAN with a plurality of multiple-channel wireless network client devices that maintain multiple contacts with a plurality of access points, and proposes a solution to the problem illustrated in FIG. 4, in accordance with the present invention.

FIG. 6 illustrates an example of a high throughput multiple-channel wireless network client apparatus, according with an embodiment of the present invention.

FIG. 7 illustrates another example of a high throughput multiple-channel wireless network client apparatus, according with another embodiment of the present invention.

FIG. 8 illustrates an exemplary multiple-channel portable data acquisition device, implemented in accordance with yet another embodiment of the present invention.

FIG. 9 illustrates an exemplary implementation of a multi-channel radio unit.

FIG. 10 is a flowchart illustrating a method for using a high throughput multiple-channel wireless network client apparatus, in accordance to the present invention.

### DETAILED DESCRIPTION OF THE PREFERED EMBODIMENTS OF THE INVENTION

The following detailed description is merely exemplary in nature and is not intended to limit the invention, applications and uses of the invention. Furthermore, the invention is not intended to be limited by any expressed or implied theory presented in the preceding technical field, background, brief summary or the following detailed description.

In the following detailed description of the preferred embodiments, reference is made to the accompanying drawings that form a part thereof, and in which are shown by way of illustration specific embodiments in which the invention may be practiced. It is to be understood that other embodiments may be utilized and structural changes may be made without departing from the scope of the present invention.

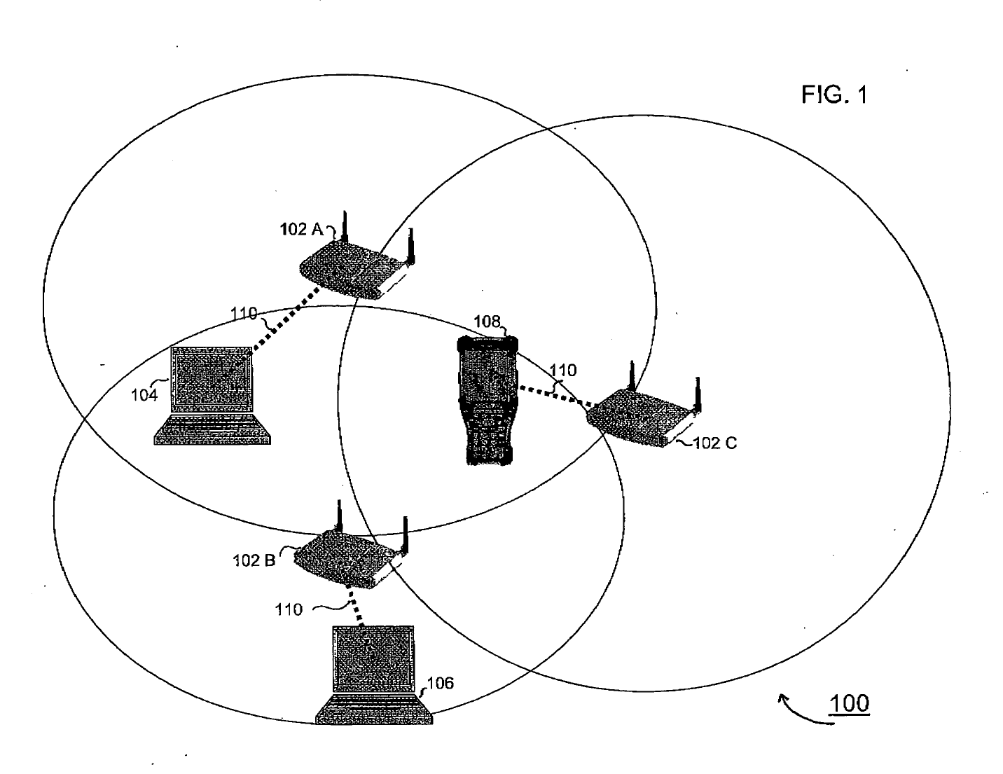

FIG. 1 illustrates a wireless LAN with a plurality of network client devices, sharing a single communication channel.

Environment 100, illustrated in FIG. 1, comprises a wireless LAN including a plurality of hosts or access points 102 A through 102 C and a plurality of single channel wireless network client apparatuses 104, 106, and 108. The access points 102 A-C are single-channel access points that communicate over the network employing either 802.11a, 802.11b, or 802.11g standard. For the purposes of the present example, the WLAN protocol employed is 802.11g. The 802.11g protocol supports a total of twelve different data transmission rates in the 2.4 GHz band. They are 1, 2, 5.5, 6, 9, 11, 12, 18, 24, 36, 48, and 54 mega bits per second.

In an example implementation, environment 100 is a warehouse with multiple access points 102 A to C that are mounted in the ceiling, at predetermined distances. Each access point has a predetermined, known coverage area. The access point coverage areas overlap in order to provide complete coverage for the entire area. A plurality of single-channel wireless network client mobile devices/apparatuses 104, 106, and 108, such as data collection devices, move in the warehouse. Examples of data collection devices encountered in the warehouse environment are scanners, mobile computers, bar code readers, RFID tag readers, etc.

Metal structures are present inside warehouse 100. The presence of metal structures in the warehouse, and implicitly in the AP's coverage area causes for the client devices radio interferences and loss of connection.

Each network client apparatus communicates with the access points over the deployed wireless LAN using single connection channels 110. The wireless network client apparatuses 104 to 108 communicate with each other via the access points 102 A-C. The transmission data rate from the access point to a network client mobile device is dependent, among other factors, on the distance between the host and the client and the position of the client mobile device with respect to the access points. For example, even though two mobile client apparatuses are at the same distance from an access point, their transmission rates can be different. This may be due to the obstacles in the direct communications path between the access point and the respective client apparatus. In the present example, the metal structures present in environment 100 cause interference and loss of connection. The single-connection network client devices make a connection with the closest access point and roam from access point to access point in order to establish a better connection while on the move.

In the scenario depicted in FIG. 1, a metal structure interposed between of wireless network client apparatus 108 and the access point 102 C severs connection 102. No matter that the apparatus 108 is stationary or mobile, apparatus 108 needs to migrate to either AP 102 A or B in order to establish a link, if an opportunity to access these APs is available. More, APs 102 A and B need to be have a sufficient coverage area to cover the position where the apparatus 108 is located.

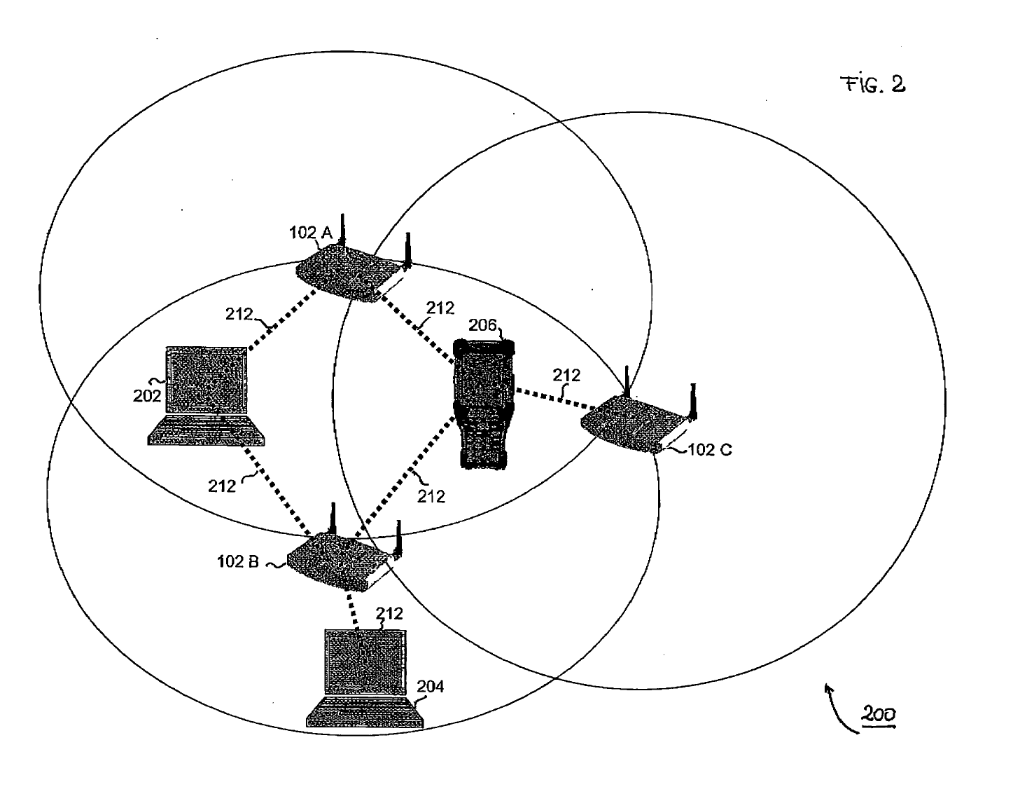

FIG. 2 illustrates a wireless LAN with a plurality of multi-channel wireless network client devices that maintain multiple contacts with a plurality of access points, according with one aspect of the present invention.

Environment 200, illustrated in FIG. 2, comprises a wireless LAN including a plurality of hosts or access points 102 A through 102 C and a plurality of multi-channel wireless network client apparatuses 202, 204, and 206, implemented in accordance with one aspect of the present invention. The plurality of hosts or access points 102 A through 102 C are single channel access points that communicate over the network employing either 802.11a, 802.11b, or 802.11 standards. For the purposes of the present example, the WLAN protocol employed is 802.11g. The 802.11g protocol supports twelve different data transmission rates in the 2.4 GHz band.

The plurality of wireless network client apparatuses 202, 204, and 206 are multi-channel wireless network client apparatuses implemented in accordance with the present invention.

Environment 200 is a warehouse with multiple access points 102 A to C that are mounted in the ceiling at predetermined distances. Each access point has a predetermined, known coverage area, that overlaps with the others in order to provide complete coverage of the entire area. A plurality of multiple-channel wireless network client mobile devices, such as data collection devices, move in the warehouse. Examples of multiple-channel wireless data collection devices encountered in the warehouse environment are scanners, mobile computers, bar code readers, RFID tag readers, etc. The method and spirit of the present invention is not limited only to the above examples of data collection devices, but it extends to all the data collection devices that will be listed further in the present document.

The data collection devices are multiple radio channel wireless network client apparatuses. Their multiple-channel feature enables them to establish multiple, concomitant radio connections with both other multiple-channel data collection devices and several access points present in their environment. The multiple-channel wireless network client apparatuses establish connections with several other single access channel or multiple access channel data collection devices present in their environment. The multiple-channel wireless network client apparatuses also establish connections with several single-channel or multiple-channel access points in who's coverage area are present.

In the example environment illustrated in FIG. 2, the warehouse, multiple-channel data collection device 204 establishes a radio connection 212 with the access point 102 B in who's coverage area it resides at the given time. The multiple-channel data collection device 204 also establishes a connection 212 with single or multiple-channel data collection device 202 or 206 and in the same time can establish connection with access points 102 A or 102 C.

If an obstacle is present in the path of connection link 212, established at a given time between multiple-channel data collection device 204 and the access point 102 B, device 204 establishes a connection with other available access points. In the event that device 204 migrates from the area covered by access point 102 B to another area, it will concomitantly establish connection with access points in the new area and with other access points that are placed outside the area.

If a metal structure is interposed between access point 102 C and the multiple-channel data collection device 206 and connection 212 is severed, the only consequence that is observed is the decrease in the quantity of data that can be forwarded from device 206 to the network through the remaining links that the device has established with other APs within its radius.

The above example in which multiple-channel data collection device 202 establishes connection with two APs, multiple-channel data collection device 204 establishes connection with only one AP and multiple-channel data collection device 206 establishes connection with three APs is merely exemplary in nature and does not intend to limit the present invention in any way. Multiple other combinations will be apparent for one skilled in the art between N multiple-channel data collection devices present an environment 200 and the N APs present in the same environment.

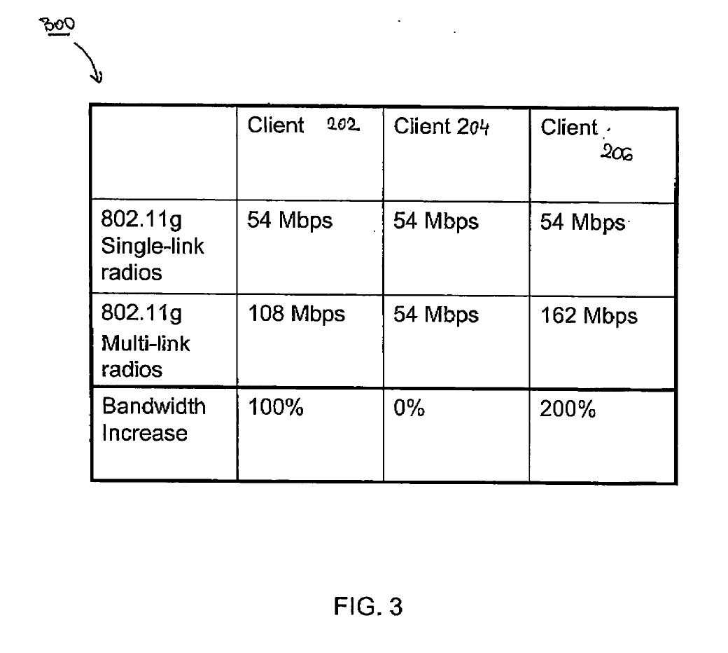

FIG. 3 is a table illustrating a comparison between the throughput of wireless 802.11g LAN network single-channel client devices and the throughput of 802.11g LAN network multiple-channel client devices that maintain concomitantly multiple contacts with multiple access points.

Single-channel data collection devices 104, 106, and 108 that establish a single radio connection with their respective APs have a maximum data throughput of 54 Mega Bits per second (Mbps). The same data collection devices with enhanced multi-channel capability of communication over multiple channels like the ones in the scenario represented in FIG. 2, show depending on the number of concomitant connections established, maximum data throughputs of 108 Mbps, 54 Mbps or 162 Mbps. It is observed that the achieved bandwidth increase for this particular case as opposed to the single-channel use case can be as high as 200%. Table 300 illustrated in FIG. 3 summarizes the above observations.

The above analysis assumes that maximum throughput is obtained. Under real circumstances the actual device throughput is less. But the above analysis is still valid and an increased throughput of maximum 200% was observed while using multiple-channel data collection devices.

For access points that employ 802.11b standard rated at 11 Mbps, typically a throughput of less than 6 Mbps of user data is obtained, often far less. The 802.11a and 802.11g hardware can give users about 18 to 22 Mbps. The maximum data modulation rate is 54 Mbps. The throughput decreases while the distance form the access point increases. The observations made above and illustrated in table 300 apply also to the case above in connection to the use of the 802.11b protocol.

WLAN throughput decreases more or less rapidly the farther a client device moves from an access point. The drop depends on how much metal, wood, concrete and other construction materials or RF interference there is between the two devices. In addition, in almost every case today, an access point is a shared medium: whatever throughput it can deliver is divided among the many users that connect to that one access point.

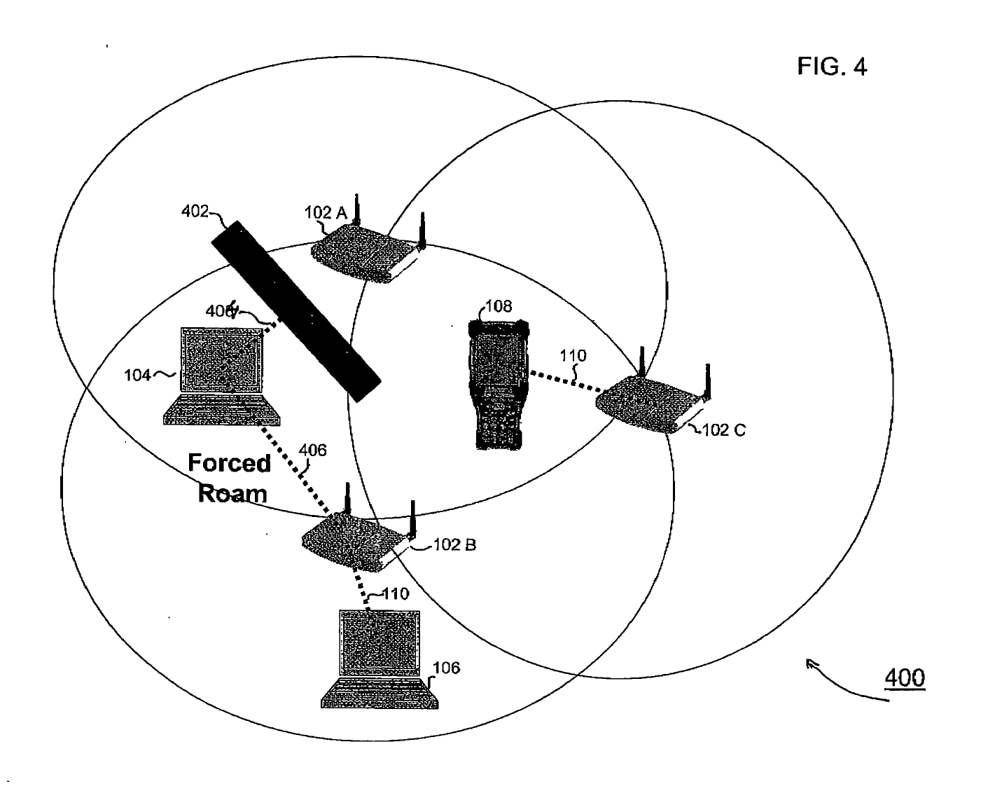

FIG. 4 illustrates a wireless LAN with a plurality of single-channel network client devices, sharing a single communication channel with the APs challenged by the presence of an obstacle in its environment.

Environment 400, illustrated in FIG. 4, comprises a wireless LAN including a plurality of hosts or access points 102 A through 102 C and a plurality of single-channel wireless network client apparatuses 104, 106, and 108. The access points 102 A-C are single channel access points that communicate over the network employing either 802.11a, 802.11b, or 802.11g standards.

In an example implementation, environment 400 is a warehouse with multiple access points 102 A to C that are mounted in the ceiling at predetermined distances. Each access point has a predetermined, known coverage area. The access point coverage areas overlap in order to provide complete coverage for the entire area. A plurality of single channel wireless network client mobile devices/apparatuses, such as data collection devices, move in the warehouse. Examples of data collection devices encountered in the warehouse environment are scanners, mobile computers, bar code readers, RFID tag readers, etc.

Each network client apparatus communicates with the access points over the deployed wireless LAN using single connection channels 110. The single-channel wireless network client apparatuses 104 to 108 communicate with each other via the access points 102. The transmission data rate from the access point to a network client mobile device is dependent among other factors on the distance between the host and the client and the position of the client mobile device with respect to the access points. For example, even though two mobile client apparatuses are at the same distance from an access point their transmission rates can be different. This may be due to the obstacles in the direct communications path between the access point and the respective client apparatus.

In the scenario depicted in FIG. 4, a large metal structure 402, such as a metallic container or truck, is interposed between the single-channel wireless network client apparatus 104 and the access point 102A. As a consequence the connection 110 is severed. No matter that single-channel apparatus 104 is stationary or mobile, apparatus 104 needs to migrate to either AP 102 B or C in order to establish a link, such as 406, if the opportunity to access these APs is available. More so, the 102 B and C APs need to be have sufficient coverage area to cover the position where the apparatus 104 is located at that moment in time. It is not unusual that at given times none of these conditions are fulfilled, therefore single-channel client apparatus 104 is completely dissociated from the network for a period of time. This translates into loss of data, low reliability and lack of overall network robustness.

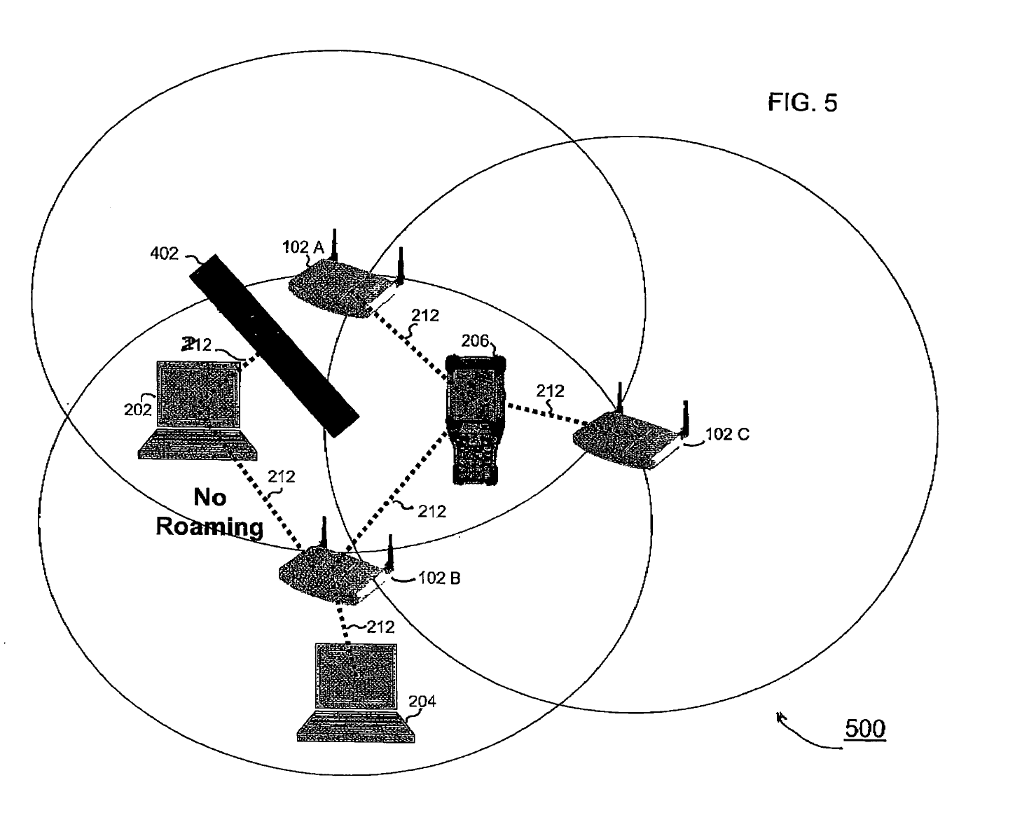

FIG. 5 illustrates a wireless LAN with a plurality of multiple-channel wireless network client devices that maintain multiple contacts with a plurality of access points, and proposes a solution to the problem illustrated in FIG. 4, in accordance with the present invention.

While using multi-channel wireless network client apparatuses in environment 400, no roaming is necessary if a large metal obstacle 402 is interposed between access point 102 A and a multi-channel wireless network client apparatus 202. If the connection 212 is severed by the presence of a large metal object, the multiple-channel network client apparatus 202 has several other radio channels available to establish contacts with other available APs. Therefore, apparatus 202 will remain linked to the network through the rest of the APs 102 B and C. Therefore, the transmission of data to the network upstream and downstream is not interrupted, this resulting in permanent connectivity and higher reliability.

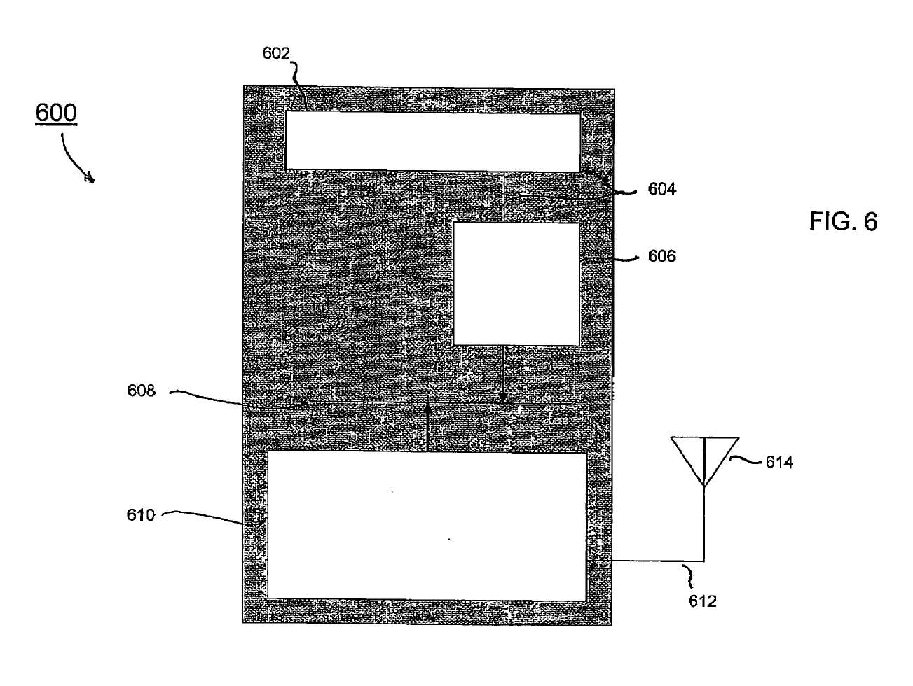

FIG. 6 illustrates an example of a high throughput and robust multi-channel wireless network client apparatus, according with an embodiment of the present invention.

Multi-channel wireless network client apparatus 600 comprises an I/O unit 602, connected through an interface 604 with an intelligence unit 606. The intelligence unit 606 connects through interface 608 with a multi-channel radio unit 610 which, through a connection means 612, is linked to an antenna assembly 614.

In one embodiment of the present invention I/O unit 602 is any one of a scanning engine, a signature capture pad, a display, a camera, a biometric device, a magnetic stripe reader, a keypad/mouse or any other device or combination of devices that a person skilled in the art would know based on the teachings of the present document to integrate the present invention into.

I/O unit 602 is liked through interface 604 with the intelligence unit 606. Examples of interfaces 604 are serial, parallel, and video interfaces. Interface 604 is elected depending on the nature of the I/O unit 602.

The intelligence unit 606 is generally a central processing unit (CPU) with an on-chip or an external memory. The CPU operates a specific customized driver software specifically developed for the multi-channel wireless network client apparatuses.

Interface 608 connects CPU 606 with the multi-channel radio unit 610. A custom firmware code/software resides and runs on the multi-channel radio unit 610. The custom firmware/code software is a customized software for the multi-channel radio unit 610 that manages the send/receive of data from the multi-channel radio unit 610. An example of possible interface 608 is a mini-PCI BUS. The multi-channel radio unit 610 is connected with the antenna assembly 614 through connection means, for example a coaxial cable 612. The antenna assembly 614 is a pair of antennas, an antenna assembly, a circular antenna, or an array of antennas, depending on the preference of the user and on the particular environment of use for the multi-channel radio device.

Multi-channel wireless network client apparatus 600 while used in an environment such as the exemplary environment 400 allows multiple concomitant radio connections to be established with several APs and with other single or multiple radio channel wireless network client apparatuses present in the environment 400. Therefore, the presence of a large obstacle in the path of the radio connections does interrupt the connection and separates the device from the network. No roaming is necessary for the device as it is the case of the single radio connection wireless network devices.

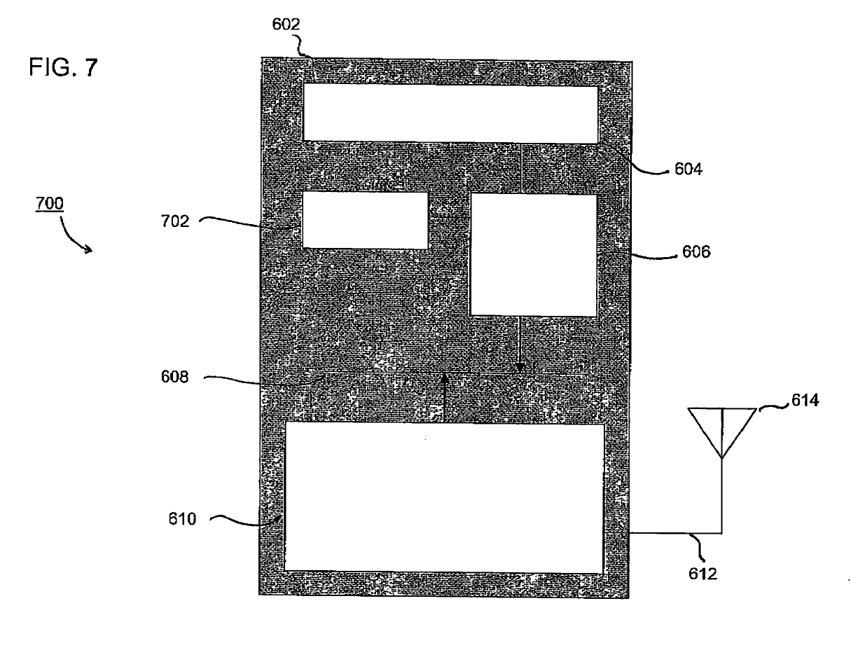

FIG. 7 illustrates another example of a high throughput wireless multi-channel network client apparatus, according with another embodiment of the present invention.

Apparatus 700 comprises an I/O unit 602 connected through a serial interface 604 with CPU 606. The CPU 606 comprises an external memory unit 702 and connects through a mini-PCU BUS 608 with a multi-channel radio unit 610. Multi-channel radio unit 610 is connected through a coaxial cable 612 to an antenna assembly 614.

Additional hardware elements are circumscribed by apparatus 700 and are not represented in FIG. 7, such as a power source, battery unit, battery charger, power supply connectors, antenna connectors, etc.

Apparatus 700 provides the same solution to the connectivity/reliability problem of a network. Apparatus 700 is capable to connect to several APs and other client apparatuses at the same time, therefore maintaining permanent connectivity to the network even while obstacles are present in its environment.

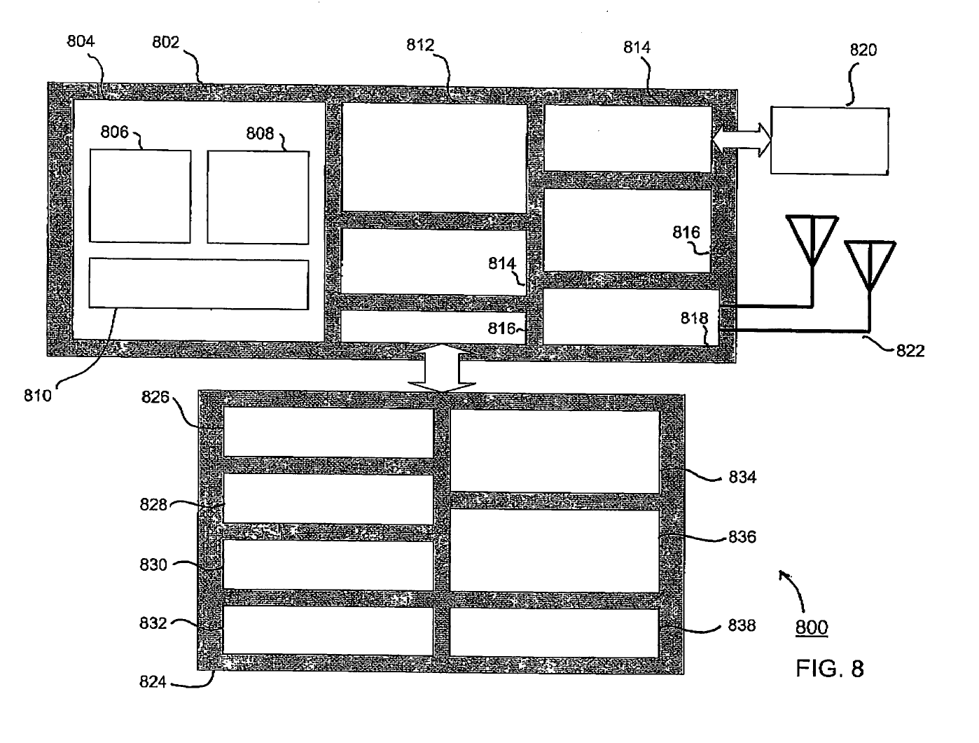

FIG. 8 illustrates an exemplary multiple-channel portable data acquisition device, implemented in accordance with yet another embodiment of the present invention.

Portable data acquisition device 800 comprises an upper module 802, and a lower module 824. The upper module 802 comprises a core 804 that encompasses a CPU 806, a memory unit 808, and an oscillator 810. Besides the core 804 the upper module 802 comprises power supply circuitry 812, serial, USB and/or audio drivers 814, I/O connectors 816, battery charger 814, multi-channel WLAN radio 816, and antenna connectors 818. All these elements are operationally, functionally and electrically connected within upper module 802. The battery charger 814 maintains either an internal or external battery 820. The antenna connectors 818 connect the upper module 802 with the antenna assembly 822.

The lower module 824 comprises keypad and triggers 826, LEDs 828, speaker and microphone 830, display 832, serial USB and JTAG ports 834, interface functionality cards such as PCMCIA/CF 836, and an imager/scanner unit 838.

The CPU unit 806 comprises and runs the driver software and radio unit 816 hosts the firmware code.

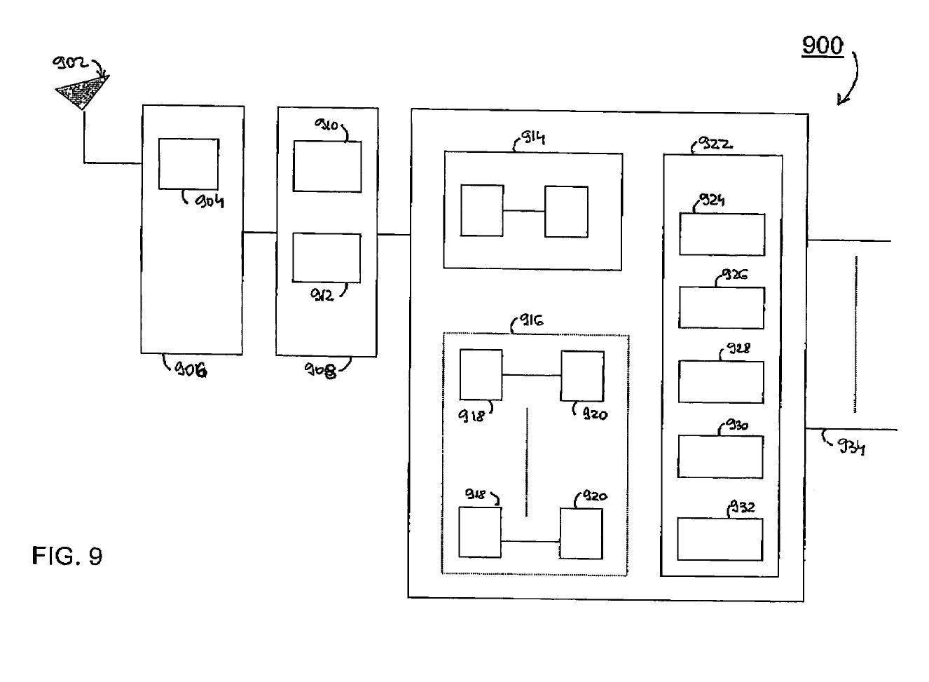

FIG. 9 illustrates an exemplary implementation of a multi-channel radio unit.

The multi-channel radio unit 900 comprises an antenna assembly 902, a wideband RF front chip 904, a wideband analog base-band chip 906, and a multi-channel digital base-band processor and MAC chip 908. The antenna assembly consists of a single antenna, a coil antenna, and/or an assembly of two or more antennas. The wideband RF front chip 904 consists of wideband A/D converter 910 and wideband DAC converter 912. The multi-channel digital base-band processor and MAC chip 908 comprises a network management resource 914, a plurality of filter/base band assembly 916, and a processor core 922. The network management resource 914 runs fast fourier transformation algorithm (FFT) 914 a and a spectrum monitor 914 b. The plurality of filter/base band assembly 916 comprises N pairs of filters 918 and base bands 920 disposed in parallel. The processor core 922 comprises operationally connected, a MAC engine 924, a PCI 926, an E-net MAC 928, a CPU 930, and a hardware encryption engine 934.

Support of WLAN multiple channel simultaneous operation enables high-performance multi-channel wireless network client apparatuses that provide up to fifty times the capacity of a single-channel client device. A highly integrated multi channel radio element employs wideband spectral processing technology to mitigate RF interference and continually monitor the complete RF spectrum.

The multi-channel wireless network client device technology also enables flexible client devices that simultaneously enable any combination of services that require good throughput, such as data-voice convergence, enhanced security, location determination and more.

The multi-channel radio wireless network unit continually monitors active and inactive channels for optimal WLAN channel selection without disrupting communication traffic flow. It also has the ability to detect 802.11 and non-802.11 interferences such as Bluetooth, microwave ovens and cordless telephones. The multi-channel radio unit supports any combination of several channels of simultaneous 802.11a/b/g communications, if desired.

If the multi-channel radio unit 900 is implemented as intelligent wideband WLAN unit then it can be a complete highly integrated WLAN system-on-chip which combines unique RF, analog, digital and systems software technology into a complete WLAN client device solution. Each component of unit 900 is optimized for wideband, multi-channel, multi-band operation to enable the most flexible service-rich client devices.

If the multi-channel radio unit 900 is implemented as a 2.4 GHz wideband RF apparatus then it can act as fully integrated direct conversion 2.4 GHz transceiver for IEEE 802.11b/g WLAN applications which support three simultaneous channels of 802.11b/g operation.

If the multi-channel radio unit 900 is implemented as 5 GHz wideband RF apparatus then it acts as a fully integrated direct conversion 5 GHz transceiver for IEEE 802.11a WLAN applications which support up to twelve simultaneous channels of 802.11a operation.

If the multi-channel radio unit 900 is implemented as analog baseband unit then it acts as high performance, low-power, fully monolithic device integrating an ultra-fast sampling 12-bit analog-to-digital converter (ADC) and two IQ high-performance 10-bit digital-to-analog converters (DACs).

If the multi-channel radio unit 900 is implemented as tri-channel digital base-band processor and MAC then it acts as a multi-channel, multi-standard device which includes a triple-speed programmable medium access controller (MAC), three concurrent IEEE 802.11a/b/g compliant digital base-bands and modems capable of achieving a peak data rate of 162 Mbps. The tri-channel digital base-band processor and MAC also incorporates a network management resource path to provide detailed RF spectrum information to the client device. Available for integrating into multi-channel digital base-band processor and MAC are hardware assisted 802.1 μl security and embedded Ethernet MACs. Together with systems software, these components offer multi-channel client device functionality and scalability.

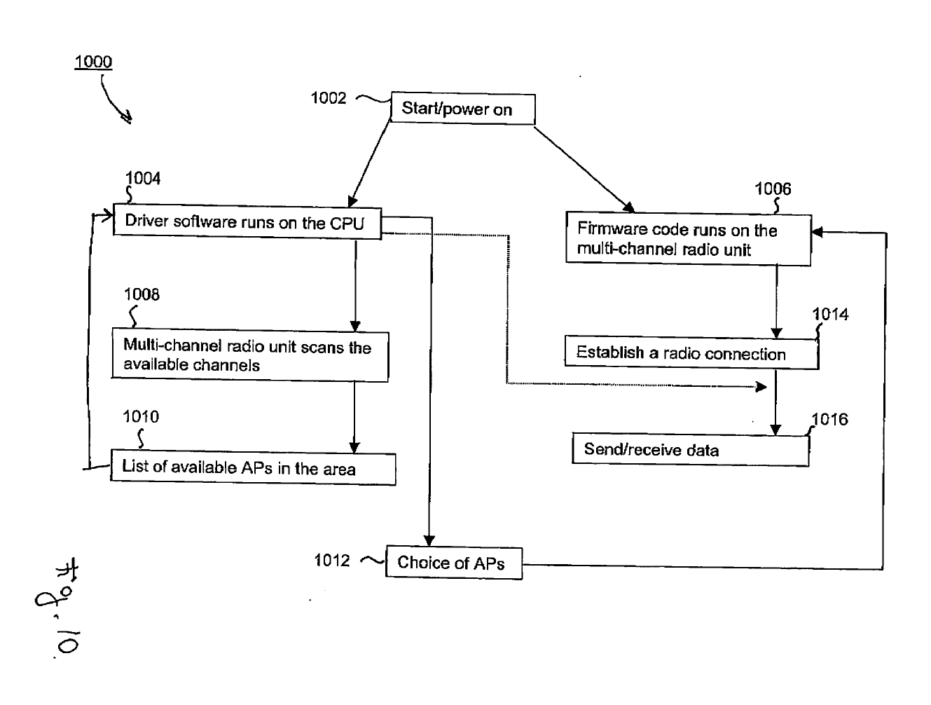

FIG. 10 is a flowchart illustrating a method for using a high throughput multiple-channel wireless network client apparatus, in accordance to the present invention.

Method 1000 consists of a sequence of steps 1002 to 1012. After powering on the multi-channel wireless network client apparatus in step 1002, the driver software stars running on the CPU in step 1004. In step 1006, the firmware code also starts running on the multi-channel radio unit. The driver software running on the CPU commands the multi-channel radio unit to scan all the available channels in step 1008. When the scan is completed a list of available APs in the area is generated, in step 1010. The list of available access ports in the area is sent back to the CPU. The driver software that resides on the CPU and initiates automatically, based on the list of available access ports, chooses one, two or as many as necessary access ports, in step 1012. The radio connection with the chosen access ports will be established concomitantly on different channels by the multi-channel radio unit, in step 1014. The channels are all available from the multi-channel radio unit. It is the driver software that tells the multi-channel radio unit what connections should be established. The succession of steps described above: scanning for available channels in step 1008, deciding, in step 1012, and establishing a connection in step 1014, is a periodically repeated sequence of steps. Once the links have been established in step 1014, the driver software dictates that data from the multi channel wireless network client device to be sent and received to and from the network and the multi-channel wireless network client device through the correct link, in step 1016.

The driver software is responsible for the management and routing of data between the connections established. This is a function that the driver software performs periodically or continuously. Scanning of the network happens periodically. The driver software is the one that makes the decisions about what connections to establish and which ones not to establish. The driver software also makes decisions about which connections to maintain and sorts the data upstream and downstream from the multi-channel wireless network client device. The driver software sorts the application data up to the right link and data from the network is sent to the application running on the multi-channel network device.

Both the driver software and firmware code strive to continuously maintain an ideal set of concomitant radio connections.

Since the current invention aims to provide a solution to the lack of reliability and robustness of the current single channel wireless network client devices, a series of specific applications can be envisioned for the present invention.

In a warehouse covered by a network of access points, the probability of a mobile client to become disconnected due to the unavailability of a 802.11a/b/g link is greatly reduced if each mobile client can maintain multiple radio connections. For example, if a single-channel network client device is wirelessly connected to a nearby AP and its view of that AP is obscured temporarily, for example by a moving truck, a degradation in performance or a complete separation from the network may occur until a new connection is established to another AP.

In a warehouse, multiple access points are mounted in the ceiling but if a mobile unit moves in the warehouse, the metal structures in the warehouse causes interference and loss of connection. The solution proposed by the present invention to integrate a multi-channel radio unit in the WLAN client mobile unit prevents the loss of connection and at the same time allows access to multiple access points.

Another advantage besides allowing for reliable use of the client device in an environment with a lot of interferences, is that the throughput from the client device to the network is increased. At least tree times more data can be sent to and from the multi-radio device. The driver software is designed such that can manage the communication effectively, therefore more total bandwidth is being used.

In a hospital environment where mobile terminals are used for bed-side data retrieval, graphics files of significant size may need to be downloaded rapidly. With a multi-link radio associated to multiple AP at the same time the bandwidth of multiple links can be aggregated to perform the download in less time, thus increasing the efficiency of the user.

Another potential environment of application for the present invention is in the development and production of high-reliability wireless portable computing devices, or wireless adapters for laptop and desktop computers. A significant improvement is found to occur in the throughput and reliability of these devices. It can be achieved by integrating the solution proposed by the present invention in these devices.

Other examples of mobile devices where the method and apparatus of the present invention are used are data collection devices such as automatic identification systems, radio frequency portals, mobile computers, telephony devices, PDAs, cameras, data storage blocks. Examples of automatic identification systems where the method of the present invention will be used are bar code readers, radio frequency identification systems, such as RFID readers, optical character recognition systems, biometric systems, such as fingerprint readers, voice readers or retina readers. The above list is deemed not to be exhaustive and other data collection devices that can benefit from the method and implementation of the present invention will be apparent to a person skilled in the relevant art.

The present invention proposes a cost effective s olution because one radio unit mounted on the client device allows simultaneous connection to up several channels instead having to have several different radios at the same time on the clients side, each using one non overlapping segment of the bandwidth.

It is to be understood that the above description is intended to be illustrative and not restrictive. Many other embodiments will be apparent to one of skill in the art upon reviewing the above description. The scope of the invention should, therefore, be determined with reference to the appended claims, along with the full scope of equivalents which such claims are entitled.

What is claimed is:

1. A method of using a high throughput multi-channel wireless network client apparatus, comprising:
running a driver software on an intelligence unit;
running a firmware code on a multi-channel radio unit;
scanning a network environment for available channels;
generating a list of available access points in said network environment;
choosing a plurality of available access points based on a custom method;
establishing multiple concomitant radio connections with all chosen access points;
exchanging data between the high throughput multi-channel wireless network client apparatus and said network; and
maintaining continuously an ideal set of concomitant radio connections.

2. The method of claim 1, wherein said scanning step is performed periodically.

3. The method of claim 1, wherein said scanning step is performed continuously.

4. The method of claim 1, wherein said driver software manages said data among said established multiple concomitant radio connections.

5. The method of claim 1, wherein said driver software routes said data between said established multiple concomitant radio connections.

6. The method of claim 1, further comprising the step of deciding which connections to establish based on a predetermined algorithm.

7. The method of claim 1, further comprising the step of deciding about the nature of said data exchanged between the client apparatus and said wireless network.

8. The method of claim 1, further comprising the step of sorting among said data for either upstream or downstream communication.

9. The method of claim 1, wherein the high throughput multi-channel wireless network client apparatus employs a IEEE 802.11a standard protocol.

10. The method of claim 9, wherein said high throughput multi-channel wireless network client apparatus exchanges data with either one of 6, 9, 12, 18, 24, 36, 48, and 54 Mbps.

11. The method of claim 9, wherein the high throughput multi-channel wireless network client apparatus uses a plurality of non-overlapping channels to exchange said data.

12. The method of claim 11, wherein said high throughput multi-channel wireless network client apparatus uses three non-overlapping channels.

13. The method of claim 1, wherein said high throughput multi-channel wireless network client apparatus employs a IEEE 802.11b standard protocol.

14. The method of claim 13, wherein said high throughput multi-channel wireless network client apparatus exchanges data with either one of 1, 2, 5.5, and 11 Mbps.

15. The method of claim 14, wherein said high throughput multi-channel wireless network client apparatus uses a plurality of non-overlapping channels to exchange said data.

16. The method of claim 15, wherein said high throughput multi-channel wireless network client apparatus uses three non-overlapping channels.

17. The method of claim 1, wherein said high throughput multi-channel wireless network client apparatus employs a IEEE 802.11g standard protocol.

18. The method of claim 17, wherein said high throughput multi-channel wireless network client apparatus exchanges data with either one of 1, 2, 5.5, 6, 9, 11, 12, 18, 24, 36, 48, and 54 Mbps.

19. The method of claim 18, wherein said high throughput multi-channel wireless network client apparatus uses a plurality of non-overlapping channels to exchange said data.

20. The method of claim 19, wherein said high throughput multi-channel wireless network client apparatus uses three non-overlapping channels.

21. A wireless network, comprising:
a plurality of access points; and
a plurality of high throughput multi-channel wireless network client devices,
wherein said plurality of access points and said plurality of high throughput multi-channel wireless network client devices being operatively connected over multiple radio channels, and
wherein said access points are one of single-channel and multi-channel access points.

22. A high throughput multi-channel wireless network client apparatus, comprising:
a multi-channel system for communication with a wireless network;
means for associating said multi-channel system with said wireless network; and
internal antenna assembly, operatively and functionally connected to the client apparatus.

23. The high throughput multi-channel wireless network client apparatus of claim 22, wherein said means for associating are dedicated software.

24. The high throughput multi-channel wireless network client apparatus of claim 23, wherein said dedicated software is a customized driver software.

25. The high throughput multi-channel wireless network client apparatus of claim 23, wherein said means for associating are customized firmware software.

26. A high throughput multi-channel wireless network client apparatus, comprising:
a data input unit;
an intelligence unit connected to said data input unit by a first interface;
a multi-channel radio unit connected to said intelligence unit by a second interface; and
an antenna assembly linked to said multi-channel radio unit.

27. The high throughput multi-channel wireless network client apparatus of claim 26, wherein said data input unit is either one of a scanning engine, a signature capture pad, a display, a camera, a biometric device, a magnetic stripe reader and keypad/mouse.

28. The high throughput multi-channel wireless network client apparatus of claim 26, wherein said intelligence unit is a CPU.

29. The high throughput multi-channel wireless network client apparatus of claim 28, wherein said CPU comprises an external memory.

30. The high throughput multi-channel wireless network client apparatus of claim 28, wherein said CPU comprises an internal memory.

31. The high throughput multi-channel wireless network client apparatus of claim 28, wherein a driver software runs on said CPU.

32. The high throughput multi-channel wireless network client apparatus of claim 29, wherein a driver software resides on said memory.

33. The high throughput multi-channel wireless network client apparatus of claim 30, wherein a driver software resides on said memory.

34. The high throughput multi-channel wireless network client apparatus of claim 26, wherein said first interface is either one of a serial interface, a parallel interface, and a video interface.

35. The high throughput multi-channel wireless network client apparatus of claim 26, wherein said second interface is a mini-PCU bus.

36. The high throughput multi-channel wireless network client apparatus of claim 26, wherein said antenna assembly is either one of a pair of antennas, an antenna assembly, a circular antenna, and an array of antennas.

37. A high throughput portable data acquisition wireless network client apparatus, comprising:
an upper module operationally connected to a lower module.

38. The high throughput portable data acquisition wireless network client apparatus of claim 37, wherein said upper module comprises operatively and functionally connected: a core, a power supply circuitry, a plurality of drivers, and a plurality of connectors.

39. The high throughput portable data acquisition wireless network client apparatus of claim 38, wherein said core comprises at least one of a CPU, a memory unit, and an oscillator.

40. The high throughput portable data acquisition wireless network client apparatus of claim 37, wherein said lower module comprises comprises operationally and functionally connected at least one of a keypad, triggers, LEDs, a speaker, a microphone, a display, a port, a card, an imager, and scanner.

41. The high throughput portable data acquisition wireless network client apparatus of claim 37, wherein said wireless network client apparatus is either one or a plurality of data collection devices.

42. The high throughput portable data acquisition wireless network client apparatus of claim 41, wherein said wireless network client apparatus is either one or a plurality of automatic identification systems (AUTO ID).

43. The high throughput portable data acquisition wireless network client apparatus of claim 42, wherein said automatic identification system is a bar code reader.

44. The high throughput portable data acquisition wireless network client apparatus of claim 42, wherein said automatic identification system is a radio frequency identification system (RFID).

45. The high throughput portable data acquisition wireless network client apparatus of claim 44, wherein said radio frequency identification system is an RFID reader.

46. The high throughput portable data acquisition wireless network client apparatus of claim 42, wherein said automatic identification system is an optical character recognition system.

47. The high throughput portable data acquisition wireless network client apparatus of claim 42, wherein said automatic identification system is a biometric system.

48. The high throughput portable data acquisition wireless network client apparatus of claim 47, wherein said biometric system is a fingerprints reader.

49. The high throughput portable data acquisition wireless network client apparatus of claim 47, wherein said biometric system is a voice reader.

50. The high throughput wireless network client apparatus of claim 47, wherein said biometric system is a retina reader.

51. The high throughput wireless network client apparatus of claim 42, wherein said plurality of data collection devices comprises radio frequency portals.

52. The high throughput wireless network client apparatus of claim 42, wherein said plurality of data collection devices comprises mobile computers.

53. The high throughput wireless network client apparatus of claim 51, wherein said mobile computers comprise radio cards.

54. The high throughput wireless network client apparatus of claim 42, wherein said plurality of data collection devices comprises telephony devices.

55. The high throughput wireless network client apparatus of claim 42, wherein said plurality of data collection devices comprises PDAs.

56. The high throughput wireless network client apparatus of claim 42, wherein said plurality of data collection devices comprises cameras.
